(19) United States
(12) Patent Application Publication
(10) Pub. No.: US 2004/0111280 A1
(43) Pub. Date: Jun. 10, 2004

(54) Method of providing vehicle information and vehicle information providing program

(75) Inventor: Tomoyuki Ohtani, Sapporo (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/315,243

(22) Filed: Dec. 10, 2002

(51) Int. Cl. G06F 17/60

(52) U.S. Cl. 705/1

(57) ABSTRACT

According to the present invention, vehicle riding information is provided that alleviates problems such as not being able to distinguish between the buses heading to different destinations when the buses stop at only a little time difference, or not being able to know whether the bus will stop at the desired destination or not and other difficulties in recognizing the bus to ride on, enabling the user to easily check the bus and then ride on the bus. This can be achieved by querying the information center about the planned ride-on bus stop and the planned ride-off bus stop, or the bus riding information, storing the “bus identifying information” of the bus specified by the information center while the bus riding information is in the portable terminal, comparing the “bus identifying information” of the route bus and the stored “bus identifying information” when getting on the route bus, and notifying the user of the comparison result. Thus it becomes possible to check whether the route bus is the desired bus or not.

### BACKGROUND OF THE INVENTION

This application claims the benefit of Japanese Patent Application No. 2001-176515 filed Jun. 12, 2001 in the Japanese Patent Office, the disclosure of which is hereby incorporated by reference.

1. Field of the Invention

The present invention generally relates to methods for providing vehicle information and a program for providing vehicle information enabling users to properly ride a vehicle, in particular to a method for providing vehicle information and a program for providing vehicle information that can notify a user of the right and wrong vehicle when getting on the vehicle, and confirm whether the vehicle the user is about to get on is the desired vehicle of the user or not.

2. Description of the Related Art

Conventionally, when using public vehicles, for example, route buses, the user has to wait for the bus to arrive at the bus stop and get on the bus when the bus arrives, and get off the bus when the bus arrives to the desired bus stop.

Furthermore, when a plurality of buses going to different destinations or a plurality of buses running through different routes stop at the bus stop, where the user waits for the bus, the user needs to check the destination of the bus that will stop at the desired bus stop, check the destination of the bus that has arrived at the bus stop, and then get on the bus.

However, it is sometimes difficult to identify the right bus, for example, when a plurality of buses heading to different destinations stop with only small time differences, and the user may not know, even if the destination is known, whether the bus will stop at the desired bus stop. Furthermore, in order to check the destination of the bus, the user must check the destination sign of the running bus and thus it is difficult to recognize the destination. Moreover, handicapped people, those having bad eye sight, such people as the elderly, illiterates, foreigners, and children may not be able to read or understand the sign.

Thus, because of the difficulty in checking the destination sign of the bus and in checking whether the bus will stop at the desired bus stop or not, the user needs to have the bus driver stop the bus and to ask the bus driver for the destination, thus the user may hinder the schedule of the bus, ride on the wrong bus, or not be able to get on the bus.

### SUMMARY OF THE INVENTION

Accordingly, it is a general object of the present invention to provide vehicle riding information that notifies the user whether the vehicle the user is about to go on is the desired vehicle or not when getting on the vehicle, enabling the user to properly go on the vehicle, and decreasing the effect on a smooth ride on to the vehicle or the effect on the vehicle schedule.

Another object of the present invention is to notify the user of the characteristics of the vehicle the user wishes to ride on, for example, the color and the type (low-floor vehicle), making it easier for the user to check for the vehicle the user is intending to ride on.

Another object of the present invention is to provide vehicle riding information that notifies the user of information regarding the approaching and stopping of the vehicle the user is intending to ride on and makes the checking on the vehicle the user is intending to ride on easier, and at the same time appropriately notifies the user of the time to board the vehicle.

The present invention achieves the above objects by providing a vehicle information storing means for storing vehicle identifying information that identifies a vehicle a user plans to ride on; a present vehicle information receiving means for receiving vehicle identifying information from present vehicle; a vehicle information comparing means for comparing the vehicle identifying information and the present vehicle information, and notifying means for notifying the user based on the comparison result.

With this construction, the vehicle identifying information is stored as the planned vehicle identifying information, the present identifying information is received from the vehicle, the planned vehicle identifying information and the present vehicle identifying information are compared, the user is notified of whether the planned vehicle identifying information and the present vehicle identifying information correspond or not, and thus check can be made as to whether the vehicle riding on is the desired vehicle or not.

The present invention achieves the above objects by providing a vehicle information receiving means for receiving a planned ride-on vehicle stop and a planned ride-off vehicle stop as vehicle riding information; and vehicle information searching means for searching vehicle identifying information of a vehicle that stops at the planned ride-on vehicle stop and then at the planned ride-off vehicle stop from a vehicle information database that stores a plurality of stops on the vehicle route and vehicle identifying information of the vehicle on the vehicle route.

With this construction, the planned ride-on vehicle stop and the planned ride-off vehicle stop are received as the vehicle riding information, and by searching for the vehicle identifying information of the vehicle that stops at the vehicle stops of the vehicle riding information from the vehicle information database, the vehicle riding information can be input and the planned vehicle identifying information can be obtained from the vehicle information database, enabling the most recent information to be obtained even if the vehicle schedule is changed.

The present invention achieves the above objects by providing vehicle information input means for inputting vehicle riding information specifying a vehicle a user plans to ride on; riding information transmitting means for transmitting the vehicle riding information; vehicle information retrieving means for specifying the vehicle based on the transmitted vehicle riding information and retrieving the vehicle information of the specified vehicle; and vehicle information receiving means for receiving the retrieved vehicle information; and notifying means for notifying the user of the received bus vehicle information.

With this construction, by inputting the bus vehicle information, specifying the vehicle based on the bus vehicle information and retrieving the vehicle information of the specified vehicle, and then notifying the user of the bus vehicle information, the outer appearance and the vehicle type of the desired vehicle can be known by the user beforehand, making it possible to easily check the vehicle to ride on, and if the user is handicapped and needs to ride on a specific vehicle, it becomes possible to pre-select the vehicle to ride on based on the vehicle type and the like.

The riding information input means input the planned ride-on vehicle stop and the planned ride-off vehicle stop as the vehicle riding information, and the vehicle information retrieving means present the information of the vehicle that stops at the vehicle stops as candidate vehicle information, the vehicle information is selected from the candidate vehicle information and the bus vehicle information is retrieved based on the selected vehicle information.

With this construction, the planned ride-on vehicle stop and the planned ride-off vehicle stop can be input, and the candidate vehicle information can be presented, and thus the vehicle information can be easily selected and the bus vehicle information can be obtained.

The riding information input means input the planned ride-on vehicle stop and the planned ride-off vehicle stop as the vehicle riding information, and the vehicle information retrieving means includes a vehicle information database that stores a plurality of stops on the vehicle route and bus vehicle information of a vehicle traveling on the vehicle route, and vehicle information searching means for searching bus vehicle information of the vehicle from the vehicle information database.

With this construction, bus vehicle information can be obtained from the vehicle information database with the vehicle riding information, and the most recent information can be obtained even if the vehicle schedule is changed.

The bus vehicle database has a plurality of scheduled bus vehicles for every vehicle route, bus vehicle information for every vehicle, and planned stopping time at each of the vehicle stops for every vehicle, and the vehicle information searching means searches for the vehicle information from the vehicle information database based on the time information.

The notifying means can notify the user of information as display information, sound information, and vibration,

Thus, information can be provided effectively with the advantages that information can be easily seen, understandable even to vision-impaired people, that the speaker of the mobile phone can be appropriately used, and that audio-visual impaired people can be aware without disturbing the others.

### BRIEF DESCRIPTION OF THE DRAWINGS

The description of the preferred embodiments of the present invention will now be explained with reference to the accompanying figures in which:

FIG. 1 is a schematic diagram showing the structure of bus riding information providing service according to one embodiment of the present invention;

FIG. 2 is a block diagram showing a portable terminal of the present invention;

FIG. 3 is a block diagram showing an information center of the present invention;

FIG. 4 is a flow chart showing processes of “bus riding right-or-wrong notice” of the bus riding information providing service according to the present invention;

FIG. 5 is a flow chart showing processes of “bus riding right-or-wrong notice” of the bus riding information providing service according to the present invention;

FIG. 6 is a flow chart showing processes of “bus riding right-or-wrong notice” of the bus riding information providing service according to the present invention;

FIG. 7 is a diagram showing each of the masters of the center data base and information providing detail file according to the present invention;

FIG. 8 is a flow chart showing processes of “riding bus information acquisition” of the bus riding information providing service according to the present invention;

FIG. 9 is a flow chart showing processes of “riding bus information acquisition” of the bus riding information providing service according to the present invention;

FIG. 10 is a view of screen image showing the “bus vehicle information” in the portable terminal according to the present invention;

FIG. 11 is a flow chart showing processes of “bus approaching notification” of the bus riding information providing service according to the present invention; and

FIG. 12 is a flow chart showing processes of “bus approaching notification” of the bus riding information providing service according to the present invention.

### DESCRIPTION OF THE PREFERRED EMBODIMENTS

In the present embodiment, the riding information providing service of the bus is given as an example of the vehicle information providing service.

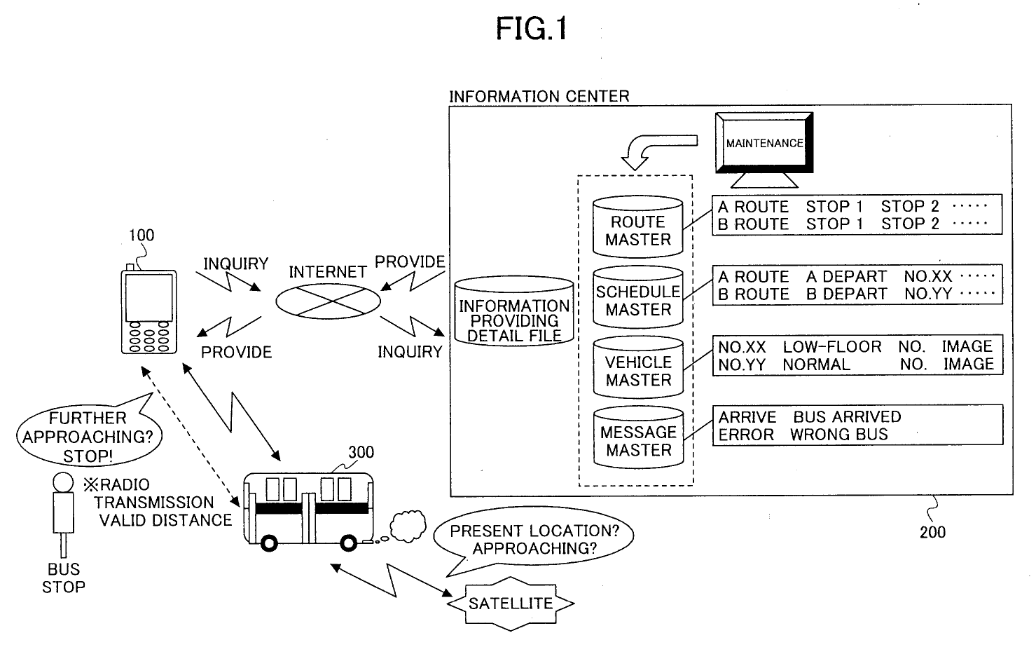

FIG. 1 is a schematic diagram showing the structure of the bus riding information providing service according to an embodiment of the present invention. The bus riding information providing service is, as shown in FIG. 1, provided with a portable terminal 100 and information center 200.

The portable terminal 100 sends inquiries to the information center 200 for information, and while receiving information from the information center 200, also obtains information from a route bus 300 and checks for the bus to ride on.

The information center 200 manages the route bus information as well as the bus schedule information and provides information in response to inquiries from the portable terminal 100.

The route bus 300 runs on the bus route in accordance with the schedule information at the information center 200 and provides information for checking to the portable terminal 100.

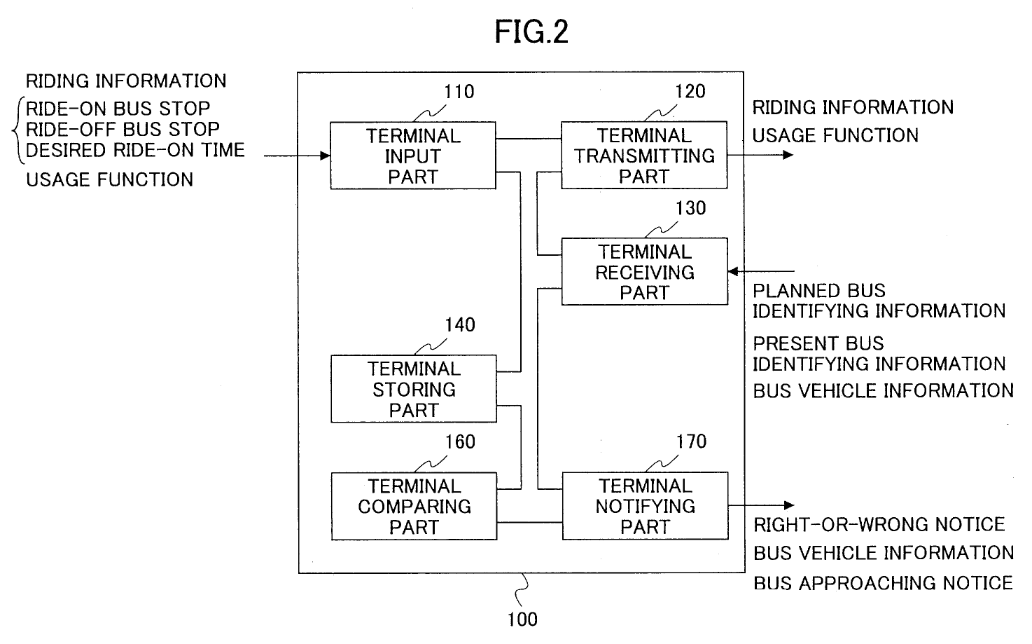

As shown in FIG. 2, the portable terminal 100 is provided with a terminal input part (riding information input means) 110, a terminal transmitting part (riding information transmitting means) 120, a terminal receiving part (bus information receiving means and present bus information receiving means) 130, a terminal storing part (bus information storing means) 140, a terminal comparing part (bus information comparing means) 160, and a terminal notifying part (notifying means) 170.

The terminal input part 110 of the portable terminal 100 is for inputting the “riding information” of the user to obtain the identifying information of the bus that the user intends to go on, i.e., to obtain the “bus identifying information” for specifying the bus and identifying or distinguishing that bus from other buses. This “riding information” is, for example, the “planned ride-on bus stop” where the user plans to get on the bus, the “planned ride-off bus stop” where the user plans to get off the bus, and the “desired ride-on time” or the time the user wishes to get on the bus at the above planned ride-on bus stop.

The terminal transmitting part 120 transmits the “riding information”, input to the terminal input part 100, to the information center 200. The terminal receiving part 130 receives the “bus identifying information” retrieved from the “riding information” at the information center 200 as the “planned bus identifying information” and receives the “bus identifying information” of the route bus 300 the user intends to ride on as the “present bus identifying information”. The terminal storing part 140 stores the “planned bus identifying information” received by the terminal receiving part 130.

The terminal comparing part 160 compares the “planned bus identifying information” stored in the terminal storing part 140 and the “present bus identifying information” received from the route bus 300 on which the user intends to ride, and determines whether the “planned bus identifying information” and the “present bus identifying information” correspond or not. The terminal notifying part 170, based on the comparison result by the terminal comparing part 160, provides the right or wrong notice regarding the route bus 300 to the user.

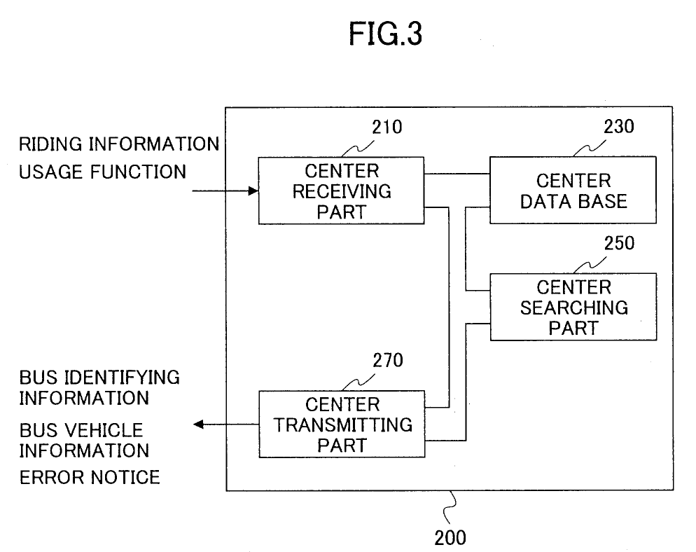

The information center 200, as shown in FIG. 3, is provided with a center receiving part 210, a center data base (bus information data base) 230, a center searching part (bus information searching means) 250, and a center transmitting part 270.

The center receiving part 210 of the information center 200 receives the “riding information” from the portable terminal 100. The center data base 230 has a route master, a schedule master and a vehicle master, the details of which will be explained hereinafter. The route master records each bus stop on the bus route for every bus route, the schedule master records the planned stopping time at each of the bus stops on the bus routes as well as the bus vehicle number that will be running, and the vehicle master records the “bus identifying information” of each of the vehicles along with the features as well as images of each of the vehicles.

The center searching part 250 searches the center data base 230 in accordance with the “riding information” received by the center receiving part 210 and retrieves the “bus identifying information” of the bus that runs through the “planned ride-on bus stop” to the “planned ride-off bus stop”. The center transmitting part 270 transmits the “bus identifying information” retrieved by the center searching part 250 to the portable terminal 100.

The route bus 300 has a unique registration number or “bus identifying information in the present embodiment, as does every bus to distinguish that bus from other busses, and route bus 300 has the portable terminal 100 receive the “bus identifying information” in response to the inquiry from the portable terminal 100.

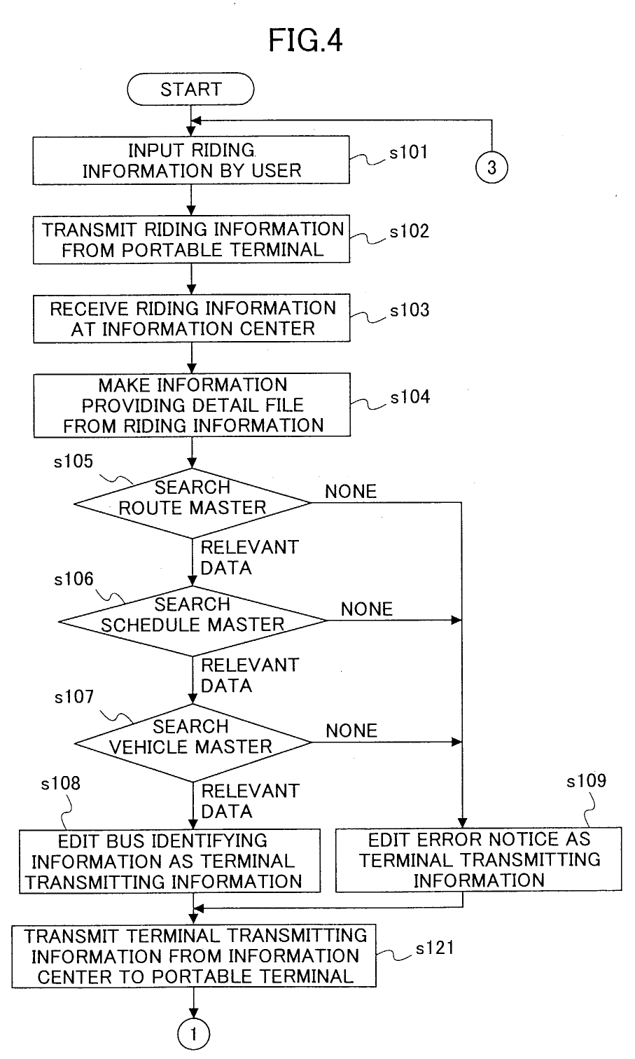

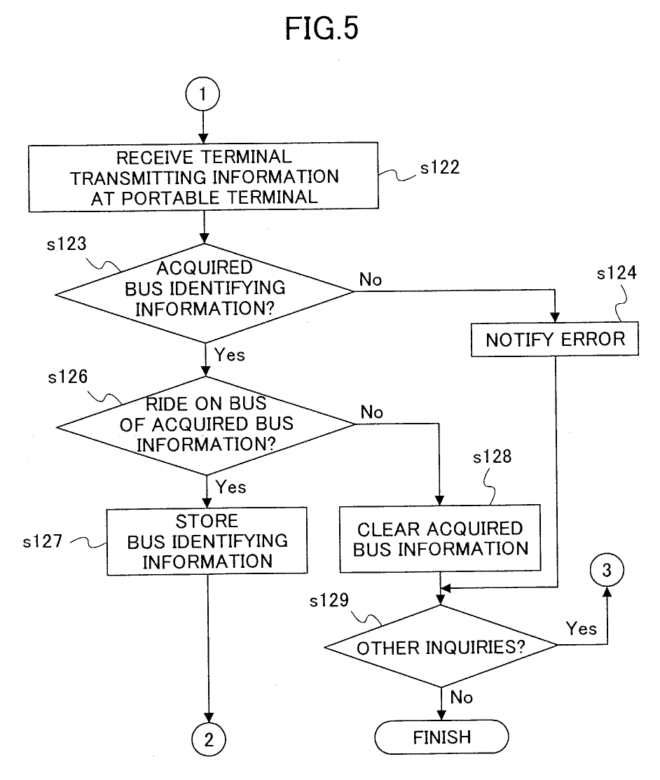

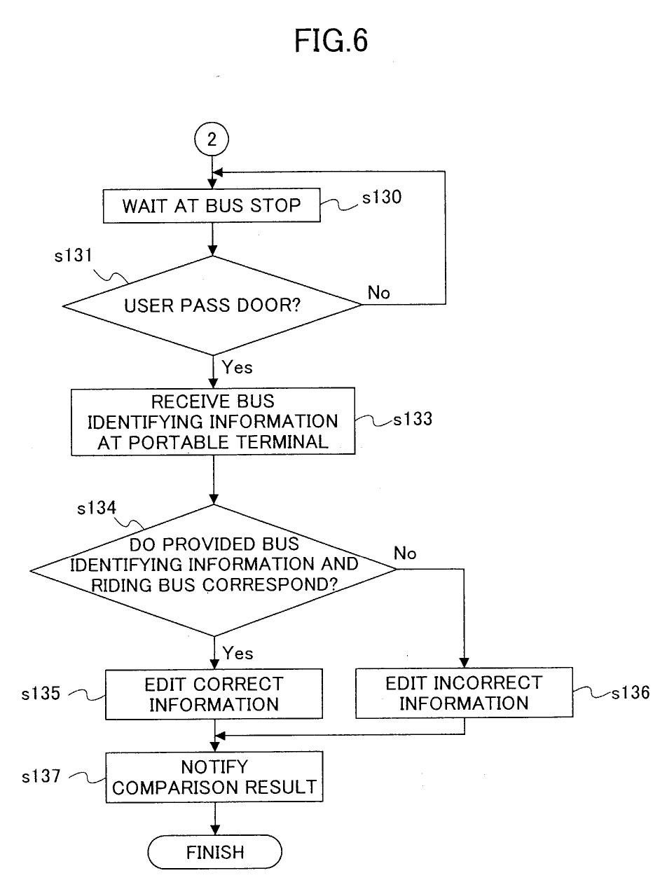

In regards to such bus riding information providing service, the processes of the “bus riding right-or-wrong notice” for notifying the user whether the bus the user is getting on is the right bus or not when the user is getting on the bus will be explained with reference to FIG. 4 through FIG. 6.

In regards to the “bus riding right-or-wrong notice”, the user downloads the “bus identifying information” of the bus the user is intending to ride on to the portable terminal 100, stores the information, compares the “bus identifying information” transmitted from the route bus 300 and then notifies the information center 200.

As shown in FIG. 4, the user inputs to the terminal input part 110, the “riding information”, in other words, the “planned ride-on bus stop” where the user plans to get on the bus, the “planned ride-off bus stop” where the user plans to get off the bus, and the “desired ride-on time” or the time the user wishes to get on the bus at the above planned ride-on bus stop (s101). In regards to this “desired ride-on time”, it may be a prerequisite, or it may automatically be set to the present time or a predetermined amount of time added to the present time. Furthermore, the predetermined amount of time added to the present time may be arbitrarily changed.

After the “riding information” is input, the portable terminal 100 and the information center 200 are connected using a modem or the communication function of the telephone, and the terminal transmitting part 120 transmits the “riding information” to the information center 200 (s102).

In the information center 200, the “riding information” transmitted from the portable terminal 100 is received by the center receiving part 210 (s103). Furthermore, information providing detail file is made from the received “riding information” (s104). The information providing detail file gives a managing number at the time of reception and gives branch numbers as there may be a plurality of information items, and then records the reception date and time, the telephone number of the portable terminal 100 from which the riding information has been transmitted, the desired bus stop or the “planned ride-on bus stop” and the desired time or the “desired ride-on time”.

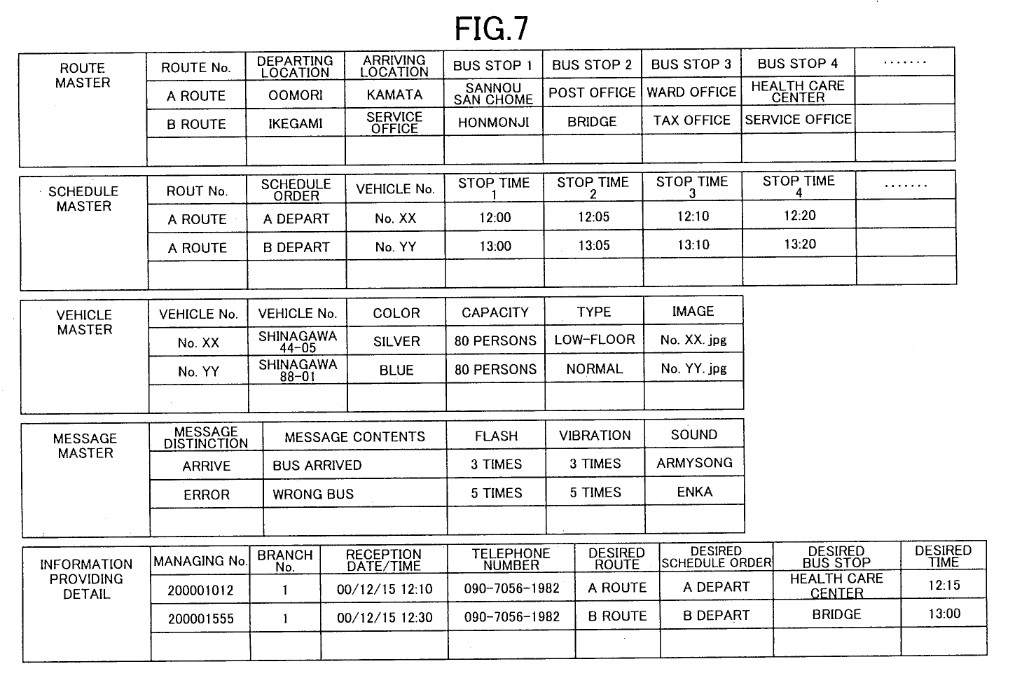

Now, each of the masters of the center data base 230 provided in the information center 200 and the file structure of the information providing detail file will be explained with reference to FIG. 7.

As shown in FIG. 7, the center data base 230 has a route master, a schedule master, a vehicle master, and a message master.

The route master records the route number, departing location, arriving location, and each of the bus stops within the route for every route. The schedule master records the route number, schedule order, the vehicle number and the stopping time at each of the bus stops within this route for every vehicle on service.

The vehicle master records the vehicle number, the registration number, the color, the seating capacity, the type and the image of a vehicle for every vehicle. Furthermore, in this embodiment, the registration number is used as the “bus identifying information”. The message master records message distinction, message contents and the method of sending messages, for example, as the number of flashes, number of vibrations, and the contents of sound for each of the message distinctions.

Furthermore, the information providing detail file also has desired route and the desired schedule order as items in addition to the managing number, the branch number, the reception date and time, the telephone number, the desired bus stop, and the desired time.

In the information center 200 having such center data base 230, after the “riding information” is received from the portable terminal 100 (s103), and the information providing detail file is made from the received “riding information” (s104), the presence of “planned ride-on bus stop” and the “planned ride-off bus stop” of the “riding information” is checked, with reference to the route master. If the “planned ride-on bus stop” and the “planned ride-off bus stop” are present, the route number that runs through the “planned ride-on bus stop” and the “planned ride-off bus stop” is searched for (s105). After the route number is obtained from the route master, the stopping time of the “planned ride-on bus stop” of the obtained route number is searched for, and the vehicle number of the bus having the stopping time after the “desired ride-on time” is obtained, with reference to the schedule master (s106). After the vehicle number is obtained from the schedule master, the registration number of the vehicle of the obtained vehicle number is obtained as the “bus identifying information”, with reference to the vehicle master (s107). Here, in addition to the obtained bus identifying information, the route number, the schedule order, the color, the image and the like of the vehicle obtained from the center data base 230 may be provided as additional information.

After the “bus identifying information” is retrieved from the center data base 230, the “bus identifying information” is edited as the “terminal transmitting information” (s108).

If relevant data are not found while searching each of the masters, an error notice is edited as the “terminal transmitting information” (s109).

In the search of each of the masters, the search of the vehicle master is not likely to occur if the data base is properly made, and thus the server operator of the information center 200 should be notified when an error occurs.

Next, the edited “terminal transmitting information” is transmitted by the center transmitting part 270 to the portable terminal 100 having the telephone number written in the information providing detail file (s121).

In the portable terminal 100, the “terminal transmitting information” transmitted from information center 200 is received by the terminal receiving part 130 (s122), and it is determined whether the received “terminal transmitting information” is d the “bus identifying information” or not (s123). If the received “terminal transmitting information” is not the “bus identifying information”, error notification is provided by the edited “terminal transmitting information” (s124).

If the received “terminal transmitting information” is the “bus identifying information”, the acquired bus information is displayed and the user inputs whether the user will ride on the bus or not (s126). If the user will not ride on the bus, the received information is cleared (s128), and determination is made as to whether to obtain new information or not (s129). When obtaining new information, the process starts again from input of “riding information” (s101) and inquiry is again made. If inquiry is not to be made, the present process is finished.

When riding on the bus having the acquired bus information, the received “bus identifying information” is stored in the terminal storing part 140 as the “planned bus identifying information”.

The user, when the “desired ride-on time” approaches, waits for the arrival of the specified bus at the input “planned ride-on bus stop” with the “planned bus identifying information” stored in the portable terminal 100 (s130).

When the route bus 300 arrives at the input “planned ride-on bus stop”, determination is made as to whether the user gets on the route bus 300 or not (s131). This determination is carried out by, for example, providing a pass sensor at the door of the route bus 300, and then determining whether the user has passed or not by radio transmission such as BLUE TOOTH from the portable terminal 100.

If the user does not pass the door, the waiting state (s130) is continued and if the user does go on the bus, the terminal receiving part 130 of the portable terminal 100 will receive the “bus identifying information” as the “present bus identifying information” because the vehicle number specifying the route bus 300 is provided near the door of the route bus 300 as the “bus identifying information” (s133).

In the portable terminal 100, the “planned bus identifying information” stored in the terminal storing part 140 and the “present bus identifying information” received from the route bus 300, which the user is about to go on are compared by the terminal comparing part 160 (s134).

If the “planned bus identifying information” and the “present bus identifying information” correspond, the comparison result is edited to be the correct information (s135) and if the “planned bus identifying information” and the “present bus identifying information” do not correspond, the comparison result is edited to be the incorrect information (s136). The edited comparison result is provided to the user by the terminal notifying part 170 (s137).

The method for notifying the user by the terminal notifying part 170 is by sound, display, or vibration. For example, if the “planned bus identifying information” of the bus the user intends to ride on and the “present bus identifying information” of the bus the user is about to ride on are the same, “ding-dong” is sounded to show correctness, and if not the same, a beeping sound is made to show incorrectness. Alternatively, if the two sets of “bus identifying information” do correspond, “specified bus” may be displayed or if the two sets of “bus identifying information” do not correspond, a vibration can be generated by the vibrate function of the portable terminal 100 to notify the user.

Next, “riding bus information acquisition” will be explained to call out information on the bus that the user intends to ride on, especially information on the outer appearance of the bus, and to have the user be aware of what kind of bus the desired bus is like beforehand.

The “riding bus information acquisition” of the bus riding information providing service, is carried out by using the portable terminal 100 and the information center 200, where the construction and the function of the portable terminal 100 and the information center 200 are substantially the same as the portable terminal 100 and the information center 200 previously explained. The following explanation is based mainly on the characteristics of the “riding bus information acquisition”.

The portable terminal 100 is provided with a terminal input part (riding information input means) 110, a terminal transmitting part (riding information transmitting part) 120, a terminal receiving part (bus information receiving part) 130, and a terminal notifying part (notifying part) 170.

The terminal input part 110 of the portable terminal 100 is to input the “riding information” of the user to obtain the information of the bus the user intends to ride on, in other words, the “bus vehicle information” to be aware of the features of the bus the user intends to ride on. This “riding information” is similar to that explained in the “bus riding right-or-wrong notice” and includes “planned ride-on bus stop” where the user plans to get on the bus, the “planned ride-off bus stop” where the user plans to get off the bus, and the “desired ride-on time” or the time the user wishes to get on the bus at the above planned ride-on bus stop. Furthermore, with regards to the “desired ride-on time”, it may be automatically obtained and not input as in the case above. If a plurality of functions are to co-exist in the portable terminal 100 such as the “riding bus information acquisition” function and the “bus riding right-or-wrong notice” function, “usage function” for selecting which function to use can also be input at the same time.

The terminal transmitting part 120 transmits the “riding information” input to the terminal input part 100 to the information center 200 to obtain the “bus vehicle information”. The terminal transmitting part 120 also transmits the “usage function” along with the “planned ride-on bus stop”, the “planned ride-off bus stop”, and the “desired ride-on time”.

The terminal receiving part 130 receives the “bus vehicle information” retrieved at the information center 200. The terminal notifying part 170 notifies the user of the “bus vehicle information” received at the terminal receiving part 130. The terminal notifying part 170 displays the narrative text and the image of the bus vehicle using the liquid crystal screen to thereby easily provide information to the user, but may also notify the user by speech using the speaker provided on the mobile phone. Therefore, information can be provided to those having bad eye sight.

The information center 200 is provided with a center receiving part 210, a center data base (bus information data base) 230, a center searching part (bus information searching means) 250, and a center transmitting part 270.

The center receiving part 210 of the information center 200 receives the “riding information” from the portable terminal 100 and also receives the “usage function”. The center data base 230 has a route master, a schedule master and a vehicle master. The center searching part 250 searches the center data base 230 with the “riding information” received at the center receiving part 210, and retrieves the “bus vehicle information” of the bus that stops at the “planned ride-on bus stop” and then to the “planned ride-off bus stop”. The center transmitting part 270 transmits the “bus vehicle information” retrieved at the center searching part 250 to the portable terminal 100.

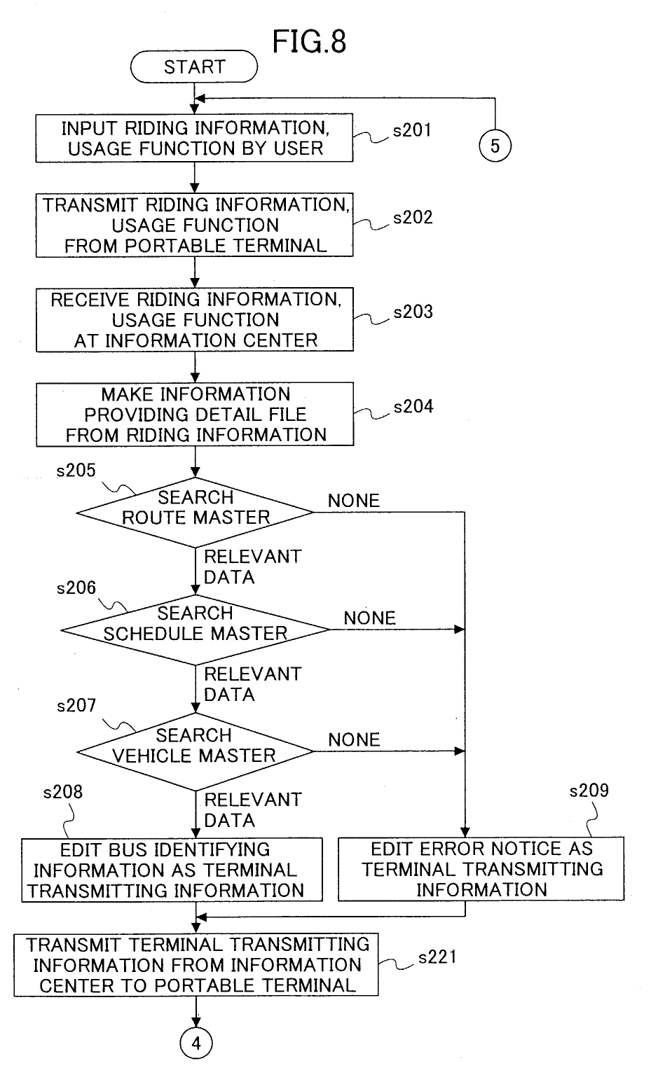

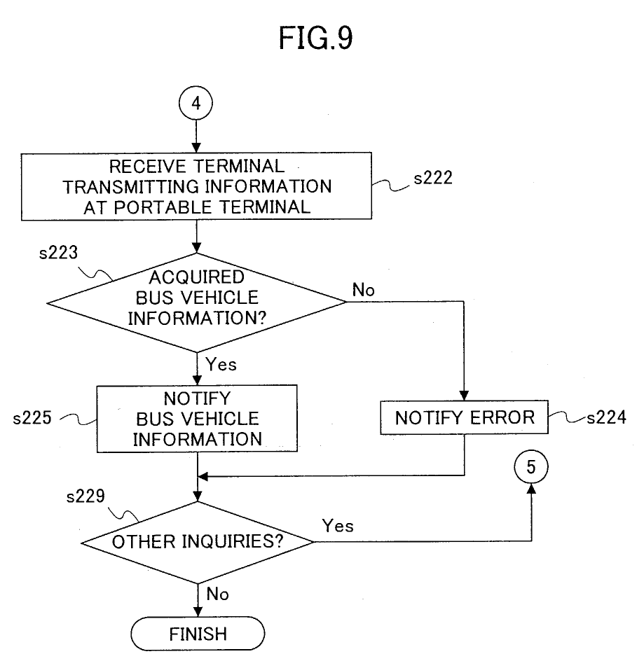

The processes of the “riding bus information acquisition” of the bus riding information providing service will be shown and explained with reference to FIG. 8 and FIG. 9.

In regards to the “riding bus information acquisition”, the user queries the information center 200, downloads the “bus vehicle information” of the bus the user intends to ride on, and thereby recognizes the shape and the outer appearance of the bus the user intends to ride on before the bus approaches, enabling the user to properly ride on the desired route bus 300.

As shown in FIG. 8, the “riding information”, in other words, the “planned ride-on bus stop” where the user plans to get on the bus, the “planned ride-off bus stop” where the user plans to get off the bus, and the “desired ride-on time” or the time the user wishes to get on the bus at the above planned ride-on bus stop are input (s201). In addition, if the portable terminal 100 is equipped with a plurality of functions, the “riding bus information acquisition” is selected and “usage function” is specified.

After the “riding information” and the “usage function” are input, the “riding information” and the “usage function” are transmitted to the information center 200 from the terminal transmitting part 120 (s202).

In the information center 200, the “riding information” and the “usage function” transmitted from the portable terminal 100 are received at the center receiving part 210 (s203). Furthermore, information providing detail file is made from the received “riding information” (s204). The information providing detail file records the managing number, the branch number, the reception date and time, the telephone number of the portable terminal 100 from where the information is transmitted, the desired bus stop or the “planned ride-on bus stop”, and the desired time or the “desired ride-on time”.

Each of the masters of the center data base 230 provided in the information center 200 and the information providing detail file are the same as those explained with regards to the “bus riding right-or-wrong notice” (FIG. 7).

After the information providing detail file is made from the “riding information” (s204), the presence of “planned ride-on bus stop” and the “planned ride-off bus stop” of the “riding information” is checked with reference to the route master. If the “planned ride-on bus stop” and the “planned ride-off bus stop” are present, the route number that runs through the “planned ride-on bus_stop” and then the “planned ride-off bus stop” is searched for (s205). After the route number is obtained from the route master, the stopping time of the “planned ride-on bus stop” of the obtained route number is searched for, and the vehicle number of the bus having the stopping time after the “desired ride-on time” is obtained with reference to the schedule master (s206). After the vehicle number is obtained from the schedule master, the registration number, the color, the type, the image and the like of the vehicle of the obtained vehicle number are obtained as the “bus vehicle information” with reference to the vehicle master (s107). Furthermore, after the route number and the schedule order are detected with the scheduling master, the route number and the schedule order are recorded as the desired route and the desired schedule order in the information providing detail file.

After the “bus vehicle information” is retrieved from the center data base 230, the “bus vehicle information” is edited as the “terminal transmitting information” (s208).

If relevant data are not found while searching each of the masters, an error notification is edited as the “terminal transmitting information” (s209).

Next, the edited “terminal transmitting_information” is transmitted by the center transmitting part 270 to the portable terminal 100 having the telephone number written in the information providing detail file (s221).

In the portable terminal 100, the_“terminal transmitting information” transmitted from the information center 200 is received by the terminal receiving part 130 (s222), and it is determined whether the received “terminal transmitting information” is the “bus vehicle information” or not (s223). If the received_“terminal transmitting information” is not the “bus vehicle information”, the user is notified of the error by the edited “terminal transmitting information”.

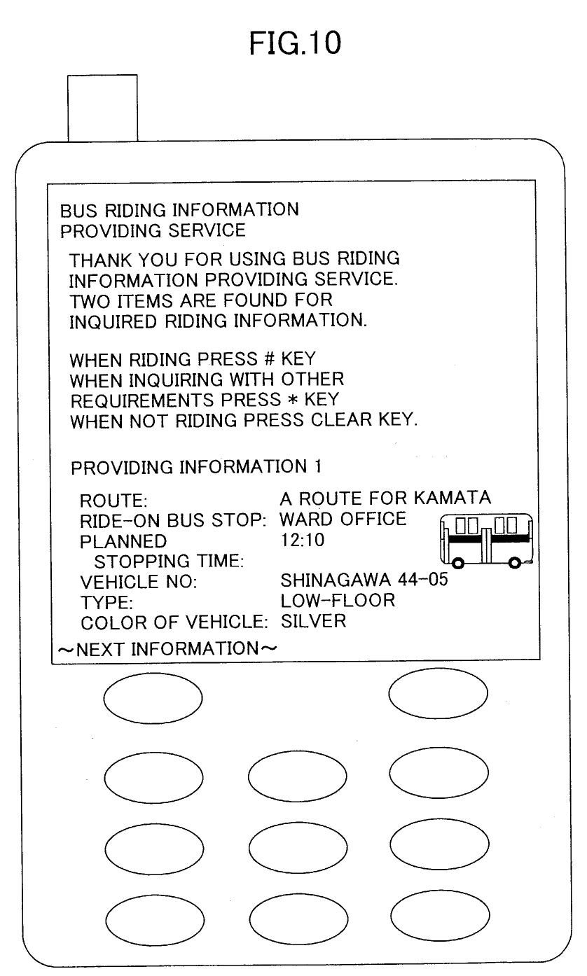

If the received “terminal transmitting_information” is the “bus vehicle information”, the user is notified of the acquired vehicle information of the bus by the terminal notifying part 170 (s225). An exemplary display of the “bus vehicle information” display in the portable terminal 100 is shown in FIG. 10. The user obtains the information of the bus the user intends to go on by looking at the display screen.

As with the “bus riding right-or-wrong notice”, the above notice is not limited to the display screen and can be provided as speech information. When notifying the user with speech information, the speech data may be directly received from the information center 200 as the “bus vehicle information” or the “bus vehicle information” obtained on the portable terminal 100 can be converted to speech data.

Subsequently, determination is made as to whether new information should be obtained or not (s229). When obtaining new information, the process starts again from input of the “riding information” (s201). When input is not repeated, the preset process is finished.

From the above processes, information on the bus the user intends to ride on, especially information such as the outer appearance of the bus, can be called out, and thus the user can be aware of what kind of bus to ride on beforehand, enabling the user to ride on the desired bus.

Next, the “bus approaching notice” for notifying the user that the bus is approaching will be explained. The “bus approaching notice” will be explained in two parts, the “first bus approaching notice” for when the bus has approached to a distance visible to the user (first approach) and the “second bus approaching notice” for when the bus further approaches the user and stops near the user (second approach).

Furthermore, the distance measurement in the present invention is carried out by using the GPS (Global Positioning System) and radio transmission as the bus positioning measuring means, where GPS is used for the “first bus approaching notice” and radio transmission is used for the “second bus approaching notice”. In the present “bus approaching notice”, assume the portable terminal has already obtained the “bus identifying information”. The obtaining process of the “bus identifying information” is as mentioned above.

The “bus approaching notice” of the bus riding information providing service is carried out by using the portable terminal 100 and the route bus 300, and furthermore, GPS using the artificial satellite and radio transmissions are used as the distance measuring means as explained above. The construction and function of the portable terminal 100 and the route bus 300 are substantially the same as those of the portable terminal 100 and the route bus 300 explained above, and the following explanation is based mainly on the characteristics of the “bus approaching notice”.

The portable terminal 100 is provided with a terminal receiving part (present bus information receiving means) 130, a terminal storing part (bus information storing means) 140, a terminal comparing part (bus information comparing means) 160, and a terminal notifying part (notifying means) 170.

The terminal receiving part 130 of the portable terminal 100 receives the “bus identifying information” of the approaching route bus 300 as the “present bus identifying information”. The terminal storing part 140 is stored with the “planned bus identifying information”.

The terminal comparing part 160 compares the “planned identifying information” stored in the terminal storing part 140 and the “present bus identifying information” received from the approaching route bus 300, and determines whether the “planned bus identifying information” and the “present bus identifying information” correspond or not. If the “planned bus identifying information” and the “present bus identifying information” match, the predetermined distance and the distance to the approaching route bus 300 are compared. The terminal notifying part 170 notifies the user that the route bus 300 is approaching based on the comparison result by the terminal comparing part 160.

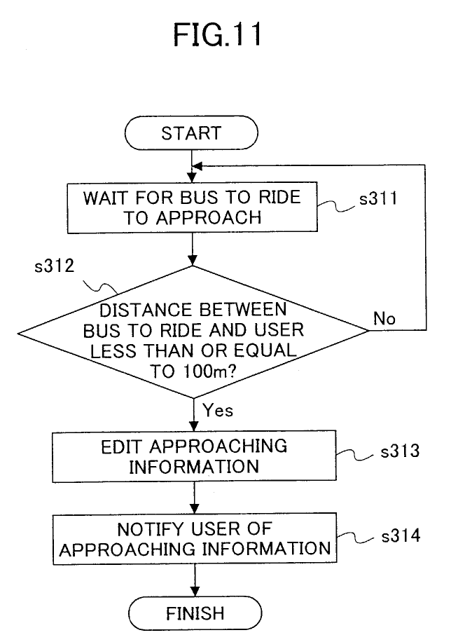

The process of the “first bus approaching notice” of the bus riding information providing service will be explained with reference to FIG. 11.

In regards to the “first bus approaching notice”, based on the “bus identifying information” obtained on the portable terminal 100, the user is notified when the route bus 300 having the “bus identifying information” approaches.

As shown in FIG. 11, the user obtains the “bus identifying information” at the portable terminal 100 and waits for the route bus 300 to approach (s311).

Next, the distance between the route bus 300 having the “bus identifying information” and the portable terminal 100 that has obtained the “bus identifying information” is measured by using the GPS, and determination is made as to whether such distance is within the first approaching distance or not. Here, the first approaching distance is 100 m and determination is made as to whether the measured distance is within 100 m or not (s312). If the measured distance is not within the first approaching distance, the process returns to the waiting state (s311) and the process is repeated.

When the route bus 300 approaches so as to be within the first approaching distance, an editing process is carried out on the first approaching information (s313) and the approaching information is provided from the terminal notifying part 170 of the portable terminal 100 to the user. (s314).

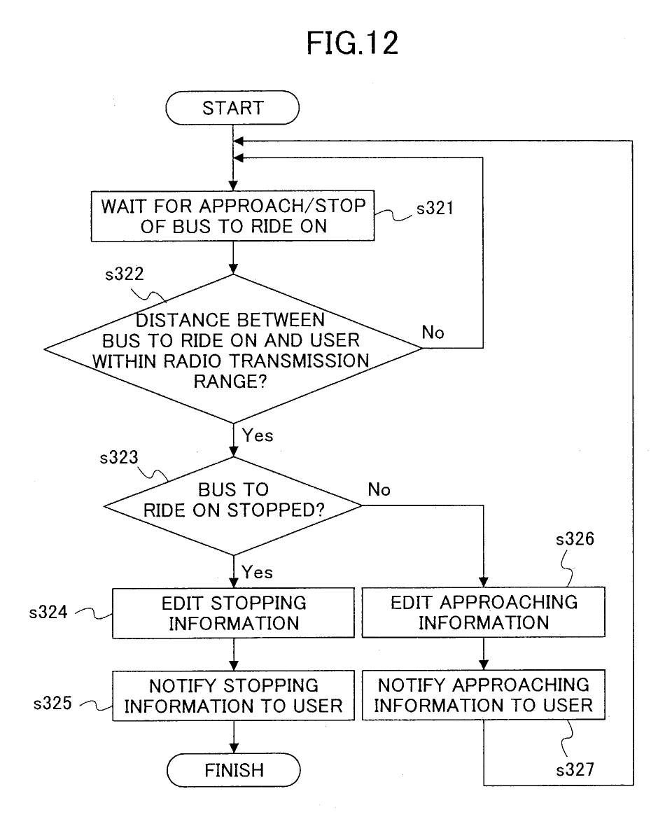

Next, the process in respect to the “second bus approaching notice” of the bus riding information providing service will be explained with reference to FIG. 12.

In regards to the “second bus approaching notification”, based on the “bus identifying information” obtained on the portable terminal 100, the user is notified when the route bus 300 having the “bus identifying information” approaches closer than the “first approaching distance”.

As shown in FIG. 12, the user obtains the “bus identifying information” on the portable terminal 100, and waits for the approach and stop of the route bus 300 (s321).

Next, the distance between the route bus 300 having the “bus identifying information” and the portable terminal 100 having the “bus identifying information” is measured by radio transmission and determination is made as to whether the measured distance is within the second approaching distance or not. Here, the second approaching distance is the radio transmission notifying range and determination is made as to whether the measured distance is within the radio transmission notifying range or not (s322). If not in the second approaching distance, the process returns to the waiting state (s321) and the process is repeated.

When the route bus 300 approaches so as to be within the second approaching distance, determination is made as to whether the route bus 300 has stopped or not (s323). When the route bus 300 has stopped, an editing process is carried out on the stopping information (S324) and the stopping information is provided from the terminal notifying part 170 of the portable terminal 100 to the user (s325).

If the route bus 300 has not stopped, an editing process is carried out on the second approaching information (s326) and the second approaching information is provided from the terminal notifying part 170 of the portable terminal 100 to the user (s327). Subsequently, the process returns to the waiting state (s321) and the process is repeated.

With the above processes, notification can be made to the user when the route bus approaches. Furthermore, in accordance to the approaching distance of the route bus, selection of notifying/not notifying can be made, and notifying contents can be changed.

In the present embodiment, explanation is made based on the example of a bus, but can also be applied to trains, railways, and other vehicles as long as the vehicle heading for the desired destination of the user can be checked for beforehand at the time of riding.

According to the present invention, by inputting the vehicle riding information, searching for the vehicle identifying information of the desired vehicle with the vehicle riding information from the vehicle information data base, storing the vehicle identifying information as the planned vehicle identifying information, receiving the present vehicle identifying information from a vehicle, comparing the planned vehicle identifying information and the present identifying information, and notifying the user whether the planned vehicle identifying information and the present vehicle identifying information correspond or not, it becomes possible to check whether the vehicle riding on is the desired vehicle or not, and can prevent riding on the wrong vehicle thus there becomes no need to ask unnecessary questions and the schedule of the vehicle will not be hindered.

Furthermore, when the desired vehicle approaches to within the predetermined range, the approaching of the vehicle is notified to the user and the vehicle to ride on can be checked for earlier and thus the user can be prepared to go on.

Furthermore, in regards to the vehicle information presenting the outer appearance and the like of the vehicle, by searching for the vehicle information data base and obtaining the vehicle information, the user can be aware of the vehicle to ride on and thus can easily check for the vehicle to ride on.

The present invention is not limited to these embodiments, but variations and modifications may be made without departing from the scope of the present invention.

What is claimed is:

1. A method of providing vehicle information comprising the steps of:
storing vehicle identifying information identifying a vehicle a user plans to ride on as planned vehicle identifying information;
receiving present vehicle identifying information identifying a present vehicle;
comparing said planned vehicle identifying information and said present vehicle identifying information; and
notifying the user whether said planned vehicle identifying information and said present vehicle identifying information correspond or not based on said comparison result.

2. The method as claimed in claim 1, further comprising the steps of:
inputting vehicle riding information specifying the vehicle the user plans to ride on; and
acquiring said vehicle identifying information of the vehicle the user plans to ride on based on said vehicle riding information; wherein
in the step of storing vehicle identifying information, the acquired vehicle identifying information is stored as the planned vehicle identifying information.

3. The method as claimed in claim 2, wherein
in the step of inputting vehicle riding information, the user inputs a planned ride-on vehicle stop where the user plans to get on the vehicle and a planned ride-off vehicle stop where the user plans to get off the vehicle as the vehicle riding information; and
in the step of acquiring the vehicle identifying information, based on said vehicle riding information, information of the vehicle that stops at the planned ride-on vehicle stop is presented as candidate vehicle information, riding information is selected from said candidate vehicle information, and based on said selected vehicle information, said vehicle identifying information is acquired.

4. The method as claimed in claim 2, wherein
in the step of inputting vehicle riding information, the user inputs a planned ride-on vehicle stop where the user plans to get on the vehicle and a planned ride-off vehicle stop where the user plans to get off the vehicle as the vehicle riding information; and
in the step of acquiring vehicle identifying information, from the planned ride-on vehicle stop and the planned ride-off vehicle stop, vehicle identifying information of a vehicle that stops at the planned ride-on vehicle stop and then at said planned ride-off vehicle stop are acquired as said vehicle identifying information.

5. The method as claimed in claim 2, wherein
in the step of inputting vehicle identifying information, the user inputs a planned ride-on vehicle stop where the user plans to get on the vehicle, a planned ride-off vehicle stop where the user plans to get off the vehicle, and a desired ride-on time at which time the user desires to get on the vehicle at said planned ride-on vehicle stop as the vehicle riding information; and
in the step of acquiring the vehicle identifying information, vehicle identifying information of the vehicle that stops at the planned ride-on vehicle stop and then at the planned ride-off vehicle stop after the desired ride-on time is acquired as the planned vehicle identifying information.

6. The method as claimed in claim 4, wherein
in the step of storing vehicle identifying information, vehicle stop identifying information of said planned ride-off vehicle stop is stored as a planned ride-off vehicle stop identifying information;
in the step of acquiring vehicle identifying information, vehicle stop identifying information of another vehicle stop is received as a present vehicle stop identifying information;
in the step of comparing vehicle information, said planned ride-off vehicle stop identifying information and said present vehicle stop identifying information are compared; and
in the step of notifying, based on said comparison result, notification is made to the user as to whether said planned ride-off vehicle stop identifying information and said present vehicle stop identifying information correspond or not.

7. The method as claimed in claim 1, further comprising the step of:
measuring a distance to the vehicle of which said present vehicle identifying information belongs; wherein
in the step of notifying, if said planned vehicle identifying information and said present vehicle identifying information correspond, and said distance measured in said step of measuring distance is within a predetermined distance, the user is notified of the approach of the vehicle.

8. The method as claimed in claim 7, wherein
a plurality of approaching distances of the vehicle to be notified in said step of notifying exist, and the user is notified of approach of said vehicle in accordance with the approaching distance.

9. The method as claimed in claim 7, wherein
in the step of measuring distance, stopping of said vehicle is detected; and
in the step of notifying, if said planned vehicle identifying information and said present vehicle identifying information correspond, and if said stopping of the vehicle is detected in said step of measuring distance, then the user is notified of said stopping of the vehicle.

10. A method of providing vehicle information comprising the steps of:
receiving a planned ride-on vehicle stop where a user plans to get on a vehicle or a planned ride-off vehicle stop where the user plans to get off the vehicle as vehicle riding information that specifies the vehicle the user is planning to ride on; and
searching for vehicle identifying information of a vehicle that stops at the planned ride-on vehicle stop and then at said planned ride-off vehicle stop from a vehicle information database that stores a plurality of stops on the vehicle traveling route and vehicle identifying information of the vehicle on said vehicle traveling route, with said received vehicle riding information.

11. The method as claimed in claim 10, wherein
in the step of receiving vehicle riding information, in addition to said planned ride-on vehicle stop and said planned ride-off vehicle stop, the desired ride-on time at which time the user desires to get on the vehicle at said planned ride-on vehicle stop is also received;
in the step of searching for vehicle identifying information, the vehicle identifying information of the vehicle that stops at said planned ride-on vehicle stop and traveling to said planned ride-off vehicle stop after said desired ride-on time are searched for from the vehicle information data base storing a plurality of scheduled vehicles for every vehicle traveling the route, the vehicle identifying information for every vehicle, and planned stopping time for each vehicle stop for every vehicle, with the received vehicle riding information.

12. The method of providing vehicle information comprising the steps of:
inputting vehicle riding information specifying the vehicle a user plans to ride on;
transmitting said vehicle riding information;
retrieving vehicle information for specifying the vehicle based on said transmitted vehicle riding information and retrieving vehicle information of said specified vehicle;
receiving said retrieved vehicle information; and
notifying the user of said received vehicle information.

13. A program for causing a computer to execute a method of providing vehicle information, the method comprising the steps of:
storing vehicle identifying information identifying a vehicle a user plans to ride on as planned vehicle identifying information;
receiving present vehicle identifying information identifying a present vehicle;
comparing said planned vehicle identifying information and said present vehicle identifying information; and
notifying the user whether said planned vehicle identifying information and said present vehicle identifying information correspond or not based on said comparison result.

14. The program as claimed in claim 13, wherein said method further comprises the steps of:
inputting vehicle riding information specifying the vehicle the user plans to ride on; and
acquiring vehicle identifying information of the vehicle the user plans to ride on based on said vehicle riding information;
in the step of storing vehicle identifying information, the acquired vehicle identifying information is stored as the planned vehicle identifying information.

15. A program for causing a computer to execute a method of providing vehicle information, the method comprising the steps of:
receiving a planned ride-on vehicle stop where a user plans to get on the vehicle and a planned ride-off vehicle stop where the user plans to get off the vehicle as vehicle riding information that specifies the vehicle the user plans to ride on; and
searching for vehicle identifying information of a vehicle that stops at said planned ride-on vehicle stop and then at said planned ride-off vehicle stop from a vehicle information database that stores a plurality of stops on the vehicle traveling route and vehicle identifying information of the vehicle on said vehicle traveling route with said received vehicle riding information.

16. A system of providing vehicle information comprising:
vehicle information storing means for storing vehicle identifying information identifying a vehicle a user plans to ride on as planned vehicle identifying information;
present vehicle information receiving means for receiving vehicle identifying information of a present vehicle as present vehicle identifying information;
vehicle information comparing means for comparing said planned vehicle identifying information and said present vehicle identifying information; and
notifying means for notifying the user whether said planned vehicle identifying information and said present vehicle identifying information correspond or not based on said comparison result.

17. The system as claimed in claim 16, further comprising:
vehicle information input means for inputting vehicle riding information specifying a vehicle the user plans to ride on; and
vehicle information acquiring means for acquiring said vehicle identifying information of said vehicle the user plans to ride on based on said vehicle riding information; wherein
said vehicle information storing means stores the acquired vehicle identifying information as planned vehicle identifying information.

18. A system of providing vehicle information further comprising:
riding information receiving means for receiving a planned ride-on vehicle stop where a user plans to get on the vehicle and a planned ride-off vehicle stop where the user plans to get off the vehicle as said vehicle riding information for specifying the vehicle the user plans to ride on;
vehicle information searching means for searching vehicle identifying information of a vehicle that stops at said planned ride-on vehicle stop then at said planned ride-off vehicle stop from a vehicle information database that stores a plurality of stops on the vehicle traveling route and vehicle identifying information of the vehicle on said vehicle traveling route with the received vehicle riding information.

19. A medium storing a program for causing a computer to execute a method of providing vehicle information, the method comprising the steps of:
storing vehicle identifying information identifying a vehicle a user plans to ride on as planned vehicle identifying information;
receiving present vehicle identifying information identifying a present vehicle;
comparing said planned vehicle identifying information and said present vehicle identifying information; and
notifying the user whether said planned vehicle identifying information and said present identifying information correspond or not based on said comparison result.

20. The medium as claimed in claim 19, wherein said method also comprises the steps of:
inputting vehicle riding information specifying the vehicle the user plans to ride on; and
acquiring said vehicle identifying information of said vehicle the user plans to ride on based on said vehicle riding information;
in the step of storing vehicle information, said acquired vehicle identifying information is stored as the planned vehicle identifying information.

21. A medium storing a program for causing a computer to execute a method of providing vehicle information, the method comprising the steps of:
receiving a planned ride-on vehicle stop where a user plans to get on the vehicle and a planned ride-off vehicle stop where the user plans to get off the vehicle as vehicle riding information that specifies the vehicle the user plans to ride on;
searching for vehicle identifying information of a vehicle that stops at said planned ride-on vehicle stop and then at said planned ride-off vehicle stop from a vehicle information database that stores a plurality of stops on the vehicle traveling route and vehicle identifying information of the vehicle on said vehicle traveling route with said received vehicle riding information.
